(19) United States
(12) Patent Application Publication
(10) Pub. No.: US 2016/0179880 A1
(43) Pub. Date: Jun. 23, 2016

(54) SYSTEM AND METHOD FOR DETERMINING WHETHER FILES ARE APPROPRIATE FOR ADDITION INTO A COLLECTION

(71) Applicant: International Business Machines Corporation, Armonk, NY (US)

(72) Inventor: Michael Muller, Medford, MA (US)

(21) Appl. No.: 14/577,415

(22) Filed: Dec. 19, 2014

(51) Int. Cl. G06F 17/30

(52) U.S. Cl. CPC G06F 17/30424; G06F 17/30985; G06F 17/30194

(57) ABSTRACT

A computing device detects a file. The computing device identifies one or more attributes associated with the file. The computing device compares one or more attributes associated with the file to one or more attributes associated with one or more collections. Based on one or more attributes associated with the file matching one or more attributes associated with the one or more collections, the computing device stores the file in the one or more collections.

### TECHNICAL FIELD

The present invention relates generally to file storage, and more particularly to evaluating whether a file is appropriate for addition in a collection.

### BACKGROUND

Storing files in a cloud or a central storage location is becoming more common. Certain social file-sharing services allow several users to contribute files to a common repository. Often times, the common repository is structured to include collections which functions similarly to a folder. However, unlike a folder which may contain any type of file, a collection typically contains files that share a common attribute of some sort. With the sheer amount of data that may be contained in a common repository, this type of organizing structure may allow a user to locate files with more ease and precision.

### SUMMARY OF THE INVENTION

In one aspect, the present invention provides a method for determining whether to add a file to a collection. A computing device detects a file. The computing device identifies one or more attributes associated with the file. The computing device compares one or more attributes associated with the file to one or more attributes associated with one or more collections. Based on one or more attributes associated with the file matching one or more attributes associated with the one or more collections, the computing device stores the file in the one or more collections.

In another aspect, the present invention provides a program product for determining whether to add a file to a collection, comprising program instructions to detect a file; identify one or more attributes associated with the file; compare one or more attributes associated with the file to one or more attributes associated with one or more collections; and based on one or more attributes associated with the file matching one or more attributes associated with the one or more collections, store the file in the one or more collections.

In another aspect, the present invention provides a system for determining whether to add a file to a collection, comprising program instructions to detect a file; identify one or more attributes associated with the file; compare one or more attributes associated with the file to one or more attributes associated with one or more collections; and based on one or more attributes associated with the file matching one or more attributes associated with the one or more collections, store the file in the one or more collections.

### BRIEF DESCRIPTION OF THE DRAWINGS

FIG. 1 illustrates a file organization system, in accordance with an embodiment of the invention.

FIG. 2 is a flowchart illustrating the operations of the file agent of FIG. 1 in determining whether a file should be added to one or more collections, in accordance with an embodiment of the invention.

FIG. 3 is a block diagram depicting the hardware components of the file organization system of FIG. 1, in accordance with an embodiment of the invention.

FIG. 4 is a block diagram of an illustrative cloud computing environment including the file organization system of FIG. 1, in accordance with an embodiment of the invention.

FIG. 5 is a block diagram of functional layers of the illustrative cloud computing environment of FIG. 4, in accordance with an embodiment of the present invention depicts abstraction model layers according to an embodiment of the invention.

### DETAILED DESCRIPTION

Embodiments of the present invention will now be described in detail with reference to the accompanying Figures.

FIG. 1 illustrates file organization system 100, in accordance with an embodiment of the invention. In an exemplary embodiment, file organization system 100 includes computing device 110 and computing device 120 all interconnected via network 130.

In the example embodiment, network 130 is the Internet, representing a worldwide collection of networks and gateways to support communications between devices connected to the Internet. Network 130 may include, for example, wired, wireless, or fiber optic connections. In other embodiments, network 130 may be implemented as an intranet, a local area network (LAN), or a wide area network (WAN). In general, network 130 can be any combination of connections and protocols that will support communications between computing device 110 and computing device 120.

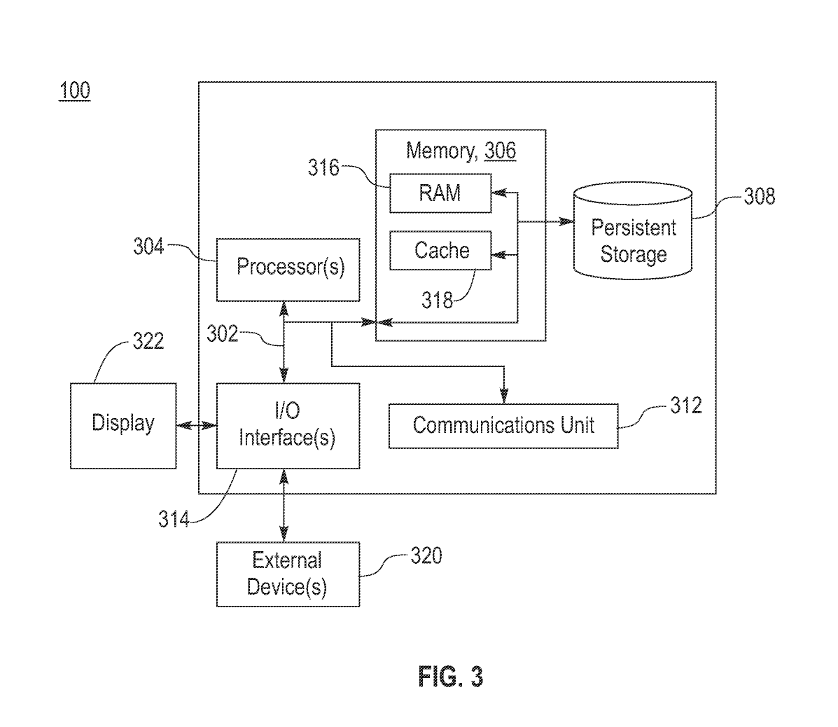

Computing device 120 includes file 122. Computing device 120 may be a desktop computer, a notebook, a laptop computer, a tablet computer, a handheld device, a smart-phone, a thin client, or any other electronic device or computing system capable of receiving and sending data to and from other computing devices such as computing device 110 via network 130. Although not shown, optionally, computing device 120 can comprise a cluster of web servers executing the same software to collectively process the requests for the web pages as distributed by a front end server and a load balancer. Computing device 120 is described in more detail with reference to FIG. 3.

File 122 is a file containing data. In the example embodiment, file 122 may be a text file, a video file, an audio file, or a file containing any other type of data. In addition, in the exemplary embodiment, file 122 includes metadata that describes one or more attributes associated with file 122.

Computing device 110 includes file agent 112 and collection 114. Computing device 110 may be a desktop computer, a notebook, a laptop computer, a tablet computer, a handheld device, a smart-phone, a thin client, or any other electronic device or computing system capable of receiving and sending data to and from other computing devices, such as social media server 140, via network 130. Although not shown, optionally, computing device 110 can comprise a cluster of web devices executing the same software to collectively process requests. Computing device 110 is described in more detail with reference to FIG. 3.

Collection 114 is a group of files. In the example embodiment, the files within collection 114 have one or more attributes in common. For example, the files within collection 114 may have one or more similar owners, one or more similar readers, similar content, or one or more other attributes in common.

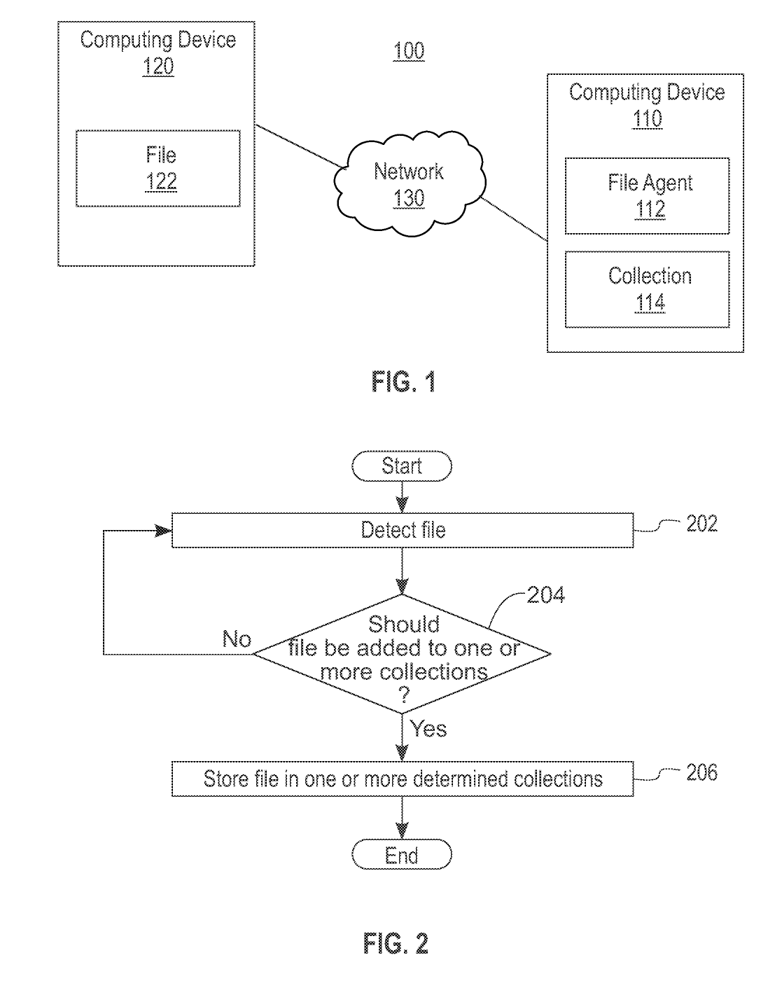

File agent 112 is capable of detecting a file and determining whether to add the file to one or more collections. In addition, file agent 112 is capable of receiving information, such as file 122 from computing device 120 via network 130. The operations and functions of file agent 112 is described in more detail with reference to FIG. 2.

FIG. 2 is a flowchart illustrating the operations of file agent 112 in determining whether to add a file to one or more collections, in accordance with an exemplary embodiment of the invention. In the example embodiment, file agent 122 detects that file 122 has been received from computing device 120 via network 130 (step 202). In other embodiments, file 122 may be located on computing device 110. In further embodiments, file 122 may be located in one or more collections within computing device 110, such as collection 114. In this further embodiment, file 122 may determine whether file 122 should be added to any other collections within computing device 110 or whether file 122 should be removed from the one or more collections it is located in. Furthermore, in the example embodiment, file 122 may have associated metadata that includes information detailing one or more attributes associated with file 122. For example, the information may detail the owners, readers and/or participants associated with file 122; the information may detail the content within file 122, contain descriptive phrases or tags related to the content within file 122, or any other information related to file 122. In the example embodiment, the information detailing one or more attributes of file 122 is input by the user of computing device 110 via a user interface.

File agent 112 determines whether file 122 should be added to one or more collections (decision 204). In the example embodiment, a collection, such as collection 114, may have associated metadata that includes information detailing one or more attributes associated with collection 114. For example, the information may detail the owners, reader and/or participants associated with one or more files within collection 114; the information may detail content associated with one or more files within collection 114, contain descriptive phrases or tags related to the content associated with one or more files within collection 114, or any other information related to collection 114. In one embodiment, the information may contain descriptive phrases or tags which describe an attribute which is contained by all files within collection 114, or an amount of files that exceeds a threshold level. In this manner, the information may detail one or more attributes that are shared among all files within collection 114 or a majority of files contained within collection 114. In a second embodiment, the information detailing one or more attributes of collection 114 may be input by the user of computing device 110 via a user interface. In the example embodiment, each file contained within collection 114 has at least one associated attribute that matches the one or more attributes detailed in the metadata associated with collection 114.

In the example embodiment, file agent 112 determines whether file 122 should be added to collection 114 by way of determining whether file 122 has at least one attribute that matches (or substantially matches) at least one attribute of collection 114. As stated above, an attribute may include an associated owner/reader/participant (or a user who has consumed/utilized the file or a file associated with the collection in some way), an associated descriptive phrase or tag, or associated content information. For example, if file 122 has an associated owner which matches an associated owner of collection 114, file agent 112 determines that file 122 should be added to collection 114. In other embodiments, file agent 112 may determine an optimal collection for file 122 by determining which collection has the most attributes in common with file 122. For example, if file agent 112 determines that a first collection has three attributes in common with file 122 and a second collection has five attributes in common with file 122, file agent 112 adds the file 122 to the optimal collection, which in this case is the second collection. An optimal collection may also be determined on a percentage basis. For example, if file 122 has associated attributes that match 10% of the attributes contained in a first collection and 25% of a second collection, file agent 112 adds file 122 to the second collection. In further embodiments, file agent 112 may add file 122 to multiple collections. For example, if file agent 112 determines that file 122 has associated attributes that match at least one attribute of a first collection and a second collection, file agent 112 may add file 122 to both the first and second collection. In even further embodiments, a threshold comparison may be utilized. For example, file agent 112 may determine whether the number or percentage of attributes associated with file 122 that match attributes associated with a collection exceeds a threshold value or percentage before adding file 122 to the collection.

In the example embodiment, file agent 112 may utilize matching methods such as string comparison, feature detection, and/or a Tf-idf (term frequency-inverse document frequency) score in determining whether Oattributes associated with a file match (or substantially match) attributes associated with a collection.

In a second embodiment, where file 122 is already located within collection 114, file agent 112 may determine whether at least one attribute associated with file 122 matches at least one attribute associated with collection 114. If file agent 112 determines that at least one attribute associated with file 122 does not match at least one attribute associated with collection 114, file agent 112 may remove file 122 from collection 114. In other embodiments, file agent 112 may perform the comparison between attributes associated with the file and attributes associated with the collection in a similar manner as described above. Therefore, in this second embodiment, file agent 112 may examine files contained within collections periodically to determine whether they are located within the correct folder(s).

If file agent 112 determines that file 122 should be added to one or more collections, such as collection 114 (decision 204, “YES” branch), file agent 114 stores file 122 in the determined one or more collections (step 206).

If file agent 112 determines that file 122 should not be added to one or more collections, such as collection 114 (decision 204, “NO” branch), file agent 114 does not store file 122 in the one or more collections and moves back to step 202. File agent 112 may then move onto the next file, if as stated in the second embodiment detailed above, file agent 112 is performing a periodic check of existing files within collections, or may wait until another file is received or uploaded.

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the accompanying claims.

FIG. 3 depicts a block diagram of components of computing device 110 and computing device 120, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 and computing device 120 include communications fabric 302, which provides communications between computer processor(s) 304, memory 306, persistent storage 308, communications unit 312, and input/output (I/O) interface(s) 314. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 316 and cache memory 318. In general, memory 306 can include any suitable volatile or non-volatile computer-readable storage media.

The programs file agent 112 and collection 114 in computing device 110; and file 122 in computing device 120 are stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 312, in these examples, provides for communications with other data processing systems or devices. In these examples, communications unit 312 includes one or more network interface cards. Communications unit 312 may provide communications through the use of either or both physical and wireless communications links. The programs file agent 112 and collection 114 in computing device 110, and file 122 in computing device 120, may be downloaded to persistent storage 308 through communications unit 312.

I/O interface(s) 314 allows for input and output of data with other devices that may be connected to computing device 110 and computing device 120. For example, I/O interface 314 may provide a connection to external devices 320 such as, a keyboard, keypad, a touch screen, and/or some other suitable input device. External devices 320 can also include portable computer-readable storage media such as, for example, thumb drives, portable optical or magnetic disks, and memory cards. Software and data used to practice embodiments of the present invention, e.g., the programs file agent 112 and collection 114 in computing device 110, and file 122 in computing device 120, can be stored on such portable computer-readable storage media and can be loaded onto persistent storage 308 via I/O interface(s) 314. I/O interface(s) 314 can also connect to a display 322.

Display 322 provides a mechanism to display data to a user and may be, for example, a computer monitor.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
a. On-demand self-service: a cloud consumer can unilaterally provision computing capabilities, such as server time and network storage, as needed automatically without requiring human interaction with the service's provider.
b. Broad network access: capabilities are available over a network and accessed through standard mechanisms that promote use by heterogeneous thin or thick client platforms (e.g., mobile phones, laptops, and PDAs).
c. Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
d. Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
e. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
a. Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
b. Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
c. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
a. Private cloud: the cloud infrastructure is operated solely for an organization. It may be managed by the organization or a third party and may exist on-premises or off-premises.
b. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
c. Public cloud: the cloud infrastructure is made available to the general public or a large industry group and is owned by an organization selling cloud services.
d. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

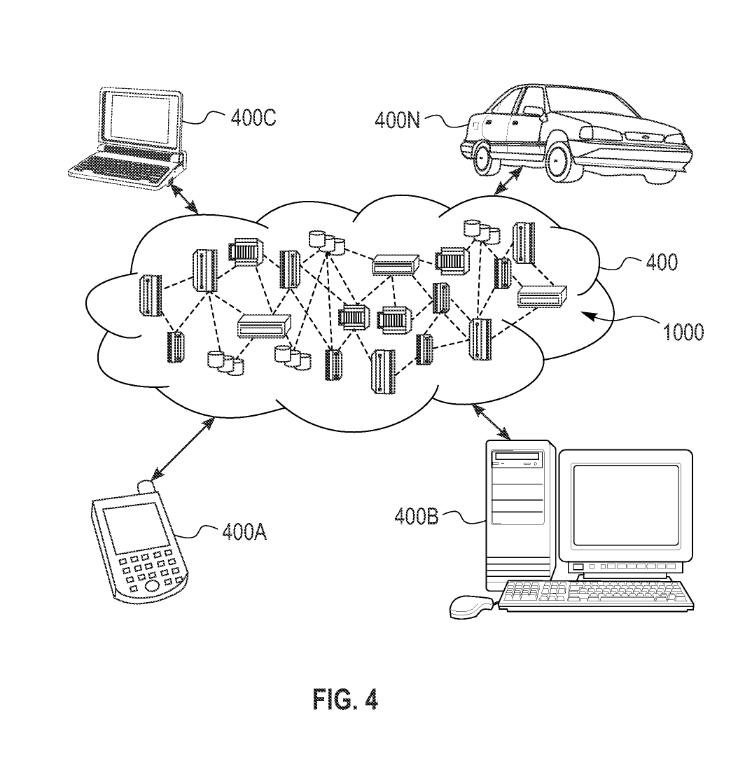

Referring now to FIG. 4, illustrative cloud computing environment 400 is depicted. As shown, cloud computing environment 400 comprises one or more cloud computing nodes 1000 with which local computing devices used by cloud consumers, such as, for example, personal digital assistant (PDA) or cellular telephone 400A, desktop computer 400B, laptop computer 400C, and/or automobile computer system 400N may communicate. In the example embodiment, nodes 1000 may be nodes such as computing device 110 and computing device 120. Nodes 1000 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 400A-N shown in FIG. 4 are intended to be illustrative only and that computing nodes 1000 and cloud computing environment 400 can communicate with any type of computerized device over any type of network and/or network addressable connection (e.g., using a web browser).

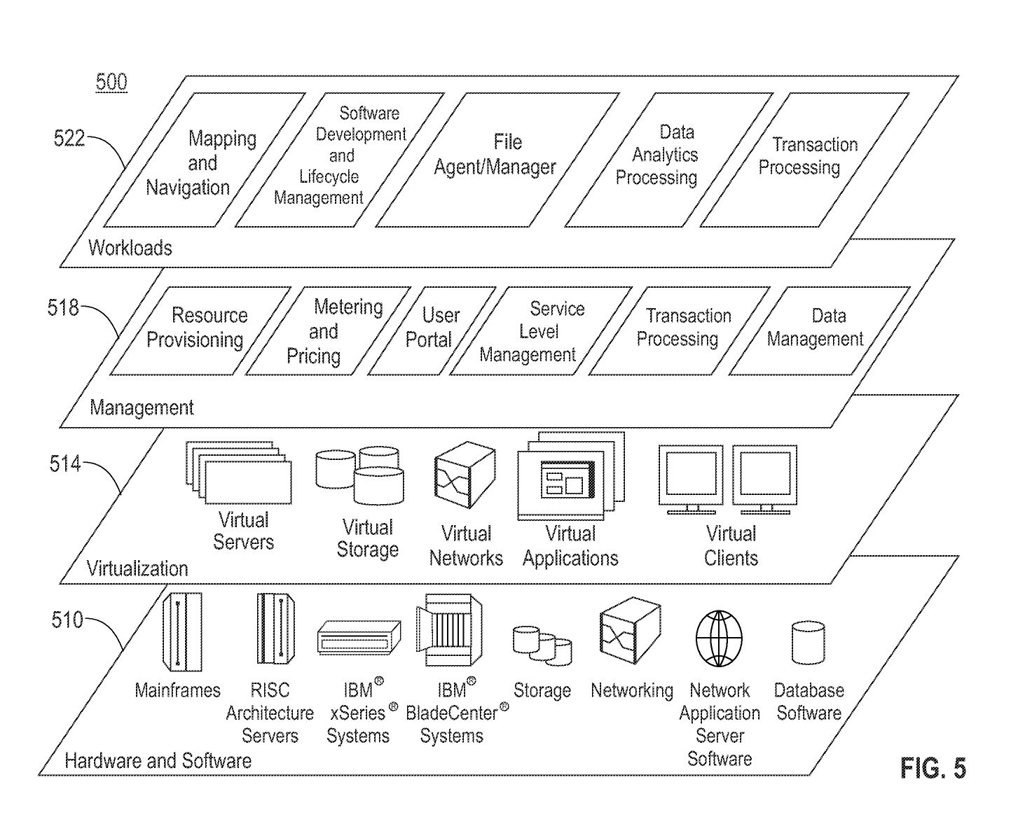

Referring now to FIG. 5, a set of functional abstraction layers, 500, provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 510 includes hardware and software components. Examples of hardware components include: mainframes; RISC (Reduced Instruction Set Computer) architecture based servers; storage devices; networks and networking components. In some embodiments, software components include network application server software.

Virtualization layer 514 provides an abstraction layer from which the following examples of virtual entities may be provided: virtual servers; virtual storage; virtual networks, including virtual private networks; virtual applications and operating systems; and virtual clients.

In one example, management layer 518 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 522 provides examples of functionality for which the cloud computing environment may be utilized. Examples of workloads and functions which may be provided from this layer include: mapping and navigation; software development and lifecycle management; virtual classroom education delivery; data analytics processing; transaction processing; and file management.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge devices. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or device. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for determining whether to store a file in a collection, comprising the steps of:
detecting, via a computing device, a file;
identifying, via the computing device, one or more attributes associated with the file;
comparing, via the computing device, one or more attributes associated with the file to one or more attributes associated with one or more collections; and
based on one or more attributes associated with the file matching one or more attributes associated with the one or more collections, storing, via the computing device, the file in the one or more collections.

2. The method of claim 1, wherein the file includes metadata which includes at least one or more descriptive tags describing one or more attributes associated with the file, and wherein the one or more collections includes metadata which includes information describing one or more attributes associated with the one or more collections.

3. The method of claim 1, wherein the one or more attributes associated with the one or more collections are determined based on one or more files contained within the one or more collections.

4. The method of claim 1, wherein the one or more attributes associated with the file detail at least one of one or more readers, one or more participants, and one or more owners associated with the file.

5. The method of claim 1, further comprising adding, via the computing device, the file to at least a first collection of the one or more collections based on at least one of the one or more attributes associated with the file matching at least one of the one or more attributes associated with the first collection.

6. The method of claim 1, further comprising adding, via the computing device, the file to a first collection of the one or more collections based on a number of attributes of the one or more attributes associated with the file matching one or more attributes associated with the first collection exceeding a threshold value.

7. The method of claim 1, further comprising adding, via the computing device, the file to a first collection of the one or more collections based on a number of attributes of the one or more attributes associated with the file matching the one or more attributes associated with the first collection exceeding a number of attributes of the one or more attributes associated with the file matching one or more attributes associated with a second collection of the one or more collections.

8. A computer program product for determining whether to store a file in a collection, the computer program product comprising:
one or more computer-readable storage devices and program instructions stored on at least one of the one or more tangible storage devices, the program instructions comprising:
program instructions to detect a file;
program instructions to identify one or more attributes associated with the file;
program instructions to compare to one or more attributes associated with the file to one or more attributes associated with one or more collections; and
based on one or more attributes associated with the file matching one or more attributes associated with the one or more collections, program instructions to store the file in the one or more collections.

9. The computer program product of claim 8, wherein the file includes metadata which includes at least one or more descriptive tags describing one or more attributes associated with the file, and wherein the one or more collections includes metadata which includes information describing one or more attributes associated with the one or more collections.

10. The computer program product of claim 8, wherein the one or more attributes associated with the one or more collections are determined based on one or more files contained within the one or more collections.

11. The computer program product of claim 8, wherein the one or more attributes associated with the file detail at least one of one or more readers, one or more participants, and one or more owners associated with the file.

12. The computer program product of claim 8, further comprising program instructions to add the file to at least a first collection of the one or more collections based on at least one of the one or more attributes associated with the file matching at least one of the one or more attributes associated with the first collection.

13. The computer program product of claim 8, further comprising program instructions to add the file to a first collection of the one or more collections based on a number of attributes of the one or more attributes associated with the file matching one or more attributes associated with the first collection exceeding a threshold value.

14. The computer program product of claim 8, further comprising the program instructions to add the file to a first collection of the one or more collections based on a number of attributes of the one or more attributes associated with the file matching one or more attributes associated with the first collection exceeding a number of attributes of the one or more attributes associated with the file matching one or more attributes associated with a second collection of the one or more collections.

15. A computer system for determining whether to store a file in a collection, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to detect a file;
program instructions to identify one or more attributes associated with the file;
program instructions to compare to one or more attributes associated with the file to one or more attributes associated with one or more collections; and
based on one or more attributes associated with the file matching one or more attributes associated with the one or more collections, program instructions to store the file in the one or more collections.

16. The computer system of claim 15, wherein the file includes metadata which includes at least one or more descriptive tags describing one or more attributes associated with the file, and wherein the one or more collections includes metadata which includes information describing one or more attributes associated with the one or more collections.

17. The computer system of claim 15, wherein the one or more attributes associated with the file detail at least one of one or more readers, one or more participants, and one or more owners associated with the file.

18. The computer system of claim 15, further comprising program instructions to add the file to at least a first collection of the one or more collections based on at least one of the one or more attributes associated with the file matching at least one of the one or more attributes associated with the first collection.

19. The computer system of claim 15, further comprising program instructions to add the file to a first collection of the one or more collections based on a number of attributes of the one or more attributes associated with the file matching one or more attributes associated with the first collection exceeding a threshold value.

20. The computer system of claim 15, further comprising the program instructions to add the file to a first collection of the one or more collections based on a number of attributes of the one or more attributes associated with the file matching one or more attributes associated with the first collection exceeding a number of attributes of the one or more attributes associated with the file matching one or more attributes associated with a second collection of the one or more collections.
